(19) United States
(12) Patent Application Publication
(10) Pub. No.: US 2024/0179132 A1
(43) Pub. Date: May 30, 2024

(54) SYSTEMS AND METHODS FOR REMOTE CONTROL MONITORING OF AN ELECTRONIC DEVICE

(71) Applicant: GE Precision Healthcare LLC, Waukesha, WI (US)

(72) Inventors: Angelo Fernandes, Bangalore (IN); Rizwan Ahmed, Bangalore (IN); Prabhunath Govindappa, Bangalore (IN); Poorvi Jain, Bangalore (IN); Shubham Sharma, Bangalore (IN)

(21) Appl. No.: 18/369,579

(22) Filed: Sep. 18, 2023

(30) Foreign Application Priority Data
Nov. 25, 2022 (IN) 202241067814

(51) Int. Cl. H04L 9/40

(52) U.S. Cl. CPC H04L 63/0272

(57) ABSTRACT

A remote user device communicatively couples to and/or controls an electronic device (e.g., a medical device) on a private network (including a firewall) from a remote location. A service enables communication between the remote user device and the electronic device. A remote user device sends a connection request to the service using a browser user interface. The service receives the connection request from the remote user device and establishes a connection to the remote user device. The service also communicatively couples to the electronic device via a gateway. The remote user device provides one or more inputs via a user interface to the service. The service transmits the one or more inputs to the gateway, which then transmits the one or more inputs to the electronic device to control operation of the electronic device.

### CROSS-REFERENCE TO RELATED APPLICATION

This application claims priority to and the benefit of India Provisional Application No. 202241067814, entitled “REMOTE CONTROL AND MONITORING OF A DEVICE USING A BROWSER-BASED APPLICATION,” filed Nov. 25, 2022, which is herein incorporated by reference in its entirety for all purposes.

### BACKGROUND

The subject matter disclosed herein relates to communications related to electronic device operation and, more particularly, to the operation of the electronic device from a remote location.

A technician or professional may request assistance from a device expert while operating a device. For example, the technician may request assistance from the device expert to accurately capture images of a patient while using the device, such as a medical device. Moreover, the technician may need assistance from the device expert (e.g., a medical device expert) when performing a critical and/or complicated scan. However, such experts may not be easily accessible to professionals, as they may be located remotely from the location of the professionals. Moreover, connecting to the device on a private network by a remote device of the device expert may be difficult due to firewalls on the private network. That is, the firewall may prevent the device expert from connecting to the device on the private network.

### BRIEF DESCRIPTION

In one embodiment, one or more tangible, non-transitory, machine-readable media, comprising machine-readable instructions that, when executed by one or more processors, cause the one or more processors to receive a connection request from a user device, wherein the user device is coupled to a first private network, connect to the user device, and connect to an electronic device via a connectivity gateway by passing through a firewall, wherein the electronic device is coupled to a second private network comprising the firewall, and the second private network is coupled to the first private network via the public network. The instructions, when executed by the one or more processors, may also cause the processors to receive data from the electronic device via the connectivity gateway, transmit the data to a browser of the user device, receive one or more inputs from the browser of the user device, and transmit the one or more inputs to the connectivity gateway for transmission to the electronic device.

In another embodiment, a device may include a transceiver and a processor. The processor may be configured to receive a connection request and connect to a first user device, connect to a first electronic device coupled to a private network including a firewall, wherein connecting to the first electronic device includes bypassing the firewall, and receive data from the first electronic device. The processor may also be configured to transmit the data to a first browser of the first user device, receive one or more inputs from the first browser of the first user device, and transmit the one or more inputs to the first electronic device.

In yet another embodiment, a method may include connecting, via a public network, to a user device coupled to a first private network, and connecting, via the public network, to an electronic device coupled to a second private network by passing through a firewall. The method may also include receiving data from the electronic device, transmitting the data to a browser of the user device, and receiving a first set of inputs from the browser of the user device. Further, the method may include transmitting the first set of inputs to the electronic device, receiving a second set of inputs from the electronic device, and transmitting the second set of inputs to the user device.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a remote control system, in accordance with the present embodiments;

FIG. 2 is a block diagram of components of the remote control system of FIG. 1, in accordance with present embodiments;

FIG. 3 is a flow diagram of processes performed in the remote control system of FIG. 2, in accordance with present embodiments;

FIG. 4 is a block diagram of a flow of data within the remote control system of FIG. 2, in accordance with present embodiments;

FIG. 5 is a flow diagram of a process to initiate remote control between a user device and an electronic device of the remote control system of FIG. 1, in accordance with present embodiments; and

FIG. 6 is a block diagram of components of gateway software within the remote control system of FIG. 2.

### DETAILED DESCRIPTION

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Any examples or illustrations given herein are not to be regarded in any way as restrictions on, limits to, or express definitions of, any term or terms with which they are utilized. Instead, these examples or illustrations are to be regarded as being described with respect to various particular embodiments and as illustrative only. Those of ordinary skill in the art will appreciate that any term or terms with which these examples or illustrations are utilized will encompass other embodiments that may or may not be given therewith or elsewhere in the specification and all such embodiments are intended to be included within the scope of that term or terms. Language designating such non-limiting examples and illustrations includes, but is not limited to: “for example,” “for instance,” “such as,” “e.g.,” “including,” “in certain embodiments,” “in some embodiments,” and “in one (an) embodiment.”

As discussed above, a user (e.g., a technician or a professional) may request assistance from a device expert while operating an electronic device. However, the expert may not be able to easily provide assistance due to geographical considerations, connectivity considerations, and/or additional considerations that may impede access of an expert device to the electronic device. Furthermore, the expert may not be able to properly assist the user in operating the electronic device using traditional methods of remote communication (e.g., telephone communication, video chat, text chat, etc.). Additionally, the expert device may not be able to connect to the electronic device on a private network due to a firewall on the private network. That is, the firewall may make it difficult for the expert device to connect to the private network. As such, systems and methods directed towards enabling the expert device to connect to and perform remote control operation of the electronic device via a remote control system may be desired. The remote control operation may enable the expert device to control and/or operate the electronic device from a remote location. Additionally or alternatively, the remote control operation may include the expert device receiving video data, image data, and/or audio data of the electronic device (e.g., in real-time), and providing feedback in the video format, image format, and/or audio format to assist the user. As an example, the expert device may provide feedback to the user by providing annotations that are viewable by the user via the electronic device.

With the foregoing in mind, the present disclosure relates to techniques for enabling a remote user device to connect to and control an electronic device (e.g., a medical device) on a private network (e.g., an office network, a hospital network, a business network, or any network restricted to a specific organization or group) from a remote location. The remote location may include any location outside boundaries of the private network. A service (e.g., a cloud service) may be implemented to enable communication between the remote user device and the electronic device. A remote user device may send a connection request (e.g., a request to connect to the electronic device) to the service using a browser user interface. The service may receive the connection request from the remote user device and establish a connection to the remote user device. Further, the service may communicatively couple or connect to the electronic device via a connectivity gateway, receive protocol traffic data from the electronic device, and then transmit the protocol traffic data to the remote user device.

The remote user device may provide one or more inputs (e.g., one or more keyboard inputs, one or more mouse inputs, and so on) via the user interface to control the operation of the electronic device. The service may receive the one or more inputs from the remote user device and transmit the one or more inputs to the gateway. Further, the gateway may transmit the one or more inputs to the server of the electronic device. Thus, the one or more inputs may be shown and/or executed by the electronic device. In this manner, the remote user device may connect to and/or control the operation of the electronic device from the remote location.

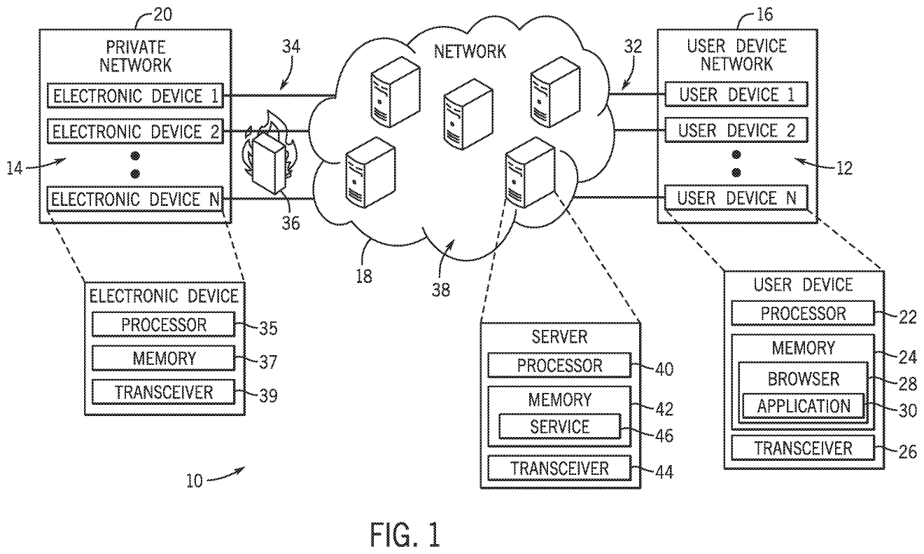

FIG. 1 is a block diagram of a remote control system 10 that facilitates a connection between one or more user devices 12 (collectively referred to herein as a single user device for convenience) and one or more electronic devices 14 (collectively referred to herein as a single electronic device for convenience). The remote control system 10 may include a user device network 16 (e.g., a private network that the user device 12 may be connected to), a public network 18 (e.g., a cloud network), and a private network 20. The user device network 16 may include the user device 12 coupled to the user device network 16. The user device 12 may include a processor and be associated with and/or operated by a user, such as a mobile phone, a smartphone, a tablet, a personal computer, a laptop computer, a workstation, a wearable device, or any suitable user device with networking capabilities. The user device 12 may be communicatively coupled to the electronic device 14 via the public network 18. The public network 18 may include any suitable network that provides connectivity and communication services to any number of devices. For example, the public network 18 may include the Internet, wide area networks (WANs), and/or any other suitable wireless network. In some embodiments, the user device 12 may communicatively couple to multiple electronic devices 14. The user device 12 may utilize a cloud connection, a network connection, or any other suitable connection, including a cellular or Wi-Fi connection to couple to the public network 18 and/or the electronic device 14. While the single user device 12 and the single electronic device 14 are referred to herein, it should be understood that this many include the one or more user devices 12 and the one or more electronic devices 14.

Further, the user device 12 may include one or more processors 22 (collectively referred to herein as a single processor for convenience, which may be implemented in any suitable form of processing circuitry), a memory 24, and a transceiver 26. The processor 22, the memory 24, and the transceiver 26 may each be communicatively coupled directly or indirectly (e.g., through or via another component, a communication bus, a network) to one another to transmit and/or receive data between one another. It should be noted that FIG. 1 is merely one example of a particular implementation and is intended to illustrate types of components that may be present in the user device 12.

The processor 22 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. In some embodiments, the processor 22 may include one or more application processors and may perform the various functions described herein. The processor 22 may be operably coupled with the memory 24 to execute code and/or other processor-executable instructions. Such programs or instructions executed by the processor 22 may be stored in any suitable article of manufacture that includes one or more tangible, computer-readable media at least collectively storing the instructions or routines, such as the memory 24.

The memory 24 may include any suitable article of manufacture for storing data and executable instructions, such as random-access memory, read-only memory, rewritable flash memory, hard drives, and optical discs. Further, in some embodiments, the memory 24 may store instructions (e.g., computer code) executable by the processor 22 to implement and/or execute a browser 28. The browser 28 may enable transmission and/or execution of a request to connect to the electronic device 14 via a user interface of the browser 28.

The transceiver 26 may facilitate communication of data between the user device 12, the public network 18, and/or one or more devices (e.g., the one or more electronic devices 14) via a first connection 32 and a second connection 34. The transceiver 26 may include, for example, one or more interfaces for a personal area network (PAN), such as a Bluetooth network, for a local area network (LAN), or a wireless local area network (WLAN), such as an 802.11x Wi-Fi network, and/or for a wide area network (WAN), such as a 3rd generation (3G) cellular network, 4th generation (4G) cellular network, long term evolution (LTE) cellular network, or long term evolution license assisted access (LTE-LAA) cellular network. The transceiver 26 may also include one or more interfaces for, for example, broadband fixed wireless access networks (WiMAX), mobile broadband Wireless networks (mobile WiMAX), asynchronous digital subscriber lines (e.g., ADSL, VDSL), digital video broadcasting-terrestrial (DVB-T) and its extension DVB Handheld (DVB-H), ultra-Wideband (UWB), alternating current (AC) power lines, and so forth. The data may include, but is not limited to, display data, temperature data, current data, voltage data, resistance data, and vital sign data (e.g., heartrate, blood pressure, and/or any other vital sign information). The transceiver 26 may support transmission and receipt of various wireless signals via one or more antennas.

The private network 20 may include the electronic device 14 communicatively coupled to the private network 20. Additionally, the private network 20 may include a firewall 36, which may monitor incoming network traffic and outgoing network traffic based on predetermined security rules. However, the incoming and outgoing network traffic between the user device 12 and the electronic device 14 may pass through the firewall 36 by establishing the connection via a service 46 within the public network 18. That is, the service 46 may enable communication between the user device network 16 (including the user device 12) and the private network 20 (including the electronic device 14) and pass the incoming and outgoing network traffic through the firewall 36. Additional details regarding the service 46 will be discussed below.

Additionally, the electronic device 14 may include one or more processors 35 (collectively referred to herein as a single processor for convenience, which may be implemented in any suitable form of processing circuitry), a memory 37, and a transceiver 39. The processor 35, the memory 37, and the transceiver 39 may each be communicatively coupled directly or indirectly (e.g., through or via another component, a communication bus, a network) to one another to transmit and/or receive data between one another. The processor 35 may be similar to and/or the same as the processor 22. The memory 37 may be similar to and/or the same as the memory 24. The transceiver 39 may be similar to and/or the same as the transceiver 26.

In some cases, the electronic device 14 may include a medical device. The medical device may sense, collect, and/or store image data, video data, audio data, and/or sensor data. For example, the medical device may include a magnetic resonance imaging (MRI) device, a computed tomography (CT) scan device, a positron emission tomography (PET) scan device, an ultrasound device, an arthrogram device, a myelogram device, a mammography device, an x-ray device, an electrocardiogram (ECG) device, an electroencephalogram (EEG) device, an electronystagmography (ENG) device, a general imaging machine (e.g., an echogram, a camera, etc.), a vital monitoring device, or any other suitable device used in healthcare that senses, collects, and/or stores data associated with the health of an individual (e.g., a patient) for diagnostics, treatment, monitoring, and/or surgical procedures.

Moreover, the user device 12 may be located at a remote location from the electronic device 14. That is, the user device 12 may be in a location where the user device 12 may not connect (e.g., directly connect, without an intermediate or intervening network) to the private network 20. In some embodiments, the user device 12 and the electronic device 14 may be associated with the same organization. Alternatively, the user device 12 and the electronic device 14 may be associated with separate or different organizations or facilities, such as, but not limited to, a manufacturer of the electronic device 14, a teleradiologist, a remote reviewer, or a trainer of medical data acquired using the user device 12. That is, the user device 12 may be associated with a medical device expert and/or imaging procedure expert or organization of such experts, separate and distinct from the facility with which the user of the electronic device 14 is associated and where a medical procedure is being performed.

The public network 18 may include one or more servers 38 (collectively referred to herein as a single server for convenience). The server 38 may enable access to the electronic device 14 from any remote location via the application 30. That is, the user device 12 may send a request to connect or communicatively couple to the server 38 via the browser 28. The server 38 may include a proxy, which may act as an intermediary between the user device 12 and the electronic device 14. Indeed, the user device 12 may send a request to connect to the electronic device 14 via the browser 28, which is sent to the server 38 (e.g., a proxy server), which then forwards the request to the electronic device 14 on behalf of the user device 12.

The server 38 may include one or more processors 40 (collectively referred to herein as a single processor for convenience, which may be implemented in any suitable form of processing circuitry), a memory 42, and a transceiver 44. The processor 40, the memory 42, and the transceiver 44 may each be communicatively coupled directly or indirectly (e.g., through or via another component, a communication bus, a network) to one another to transmit and/or receive data between one another. The processor 40 may be similar to and/or the same as the processor 22. The transceiver 44 may be similar to and/or the same as the transceiver 26.

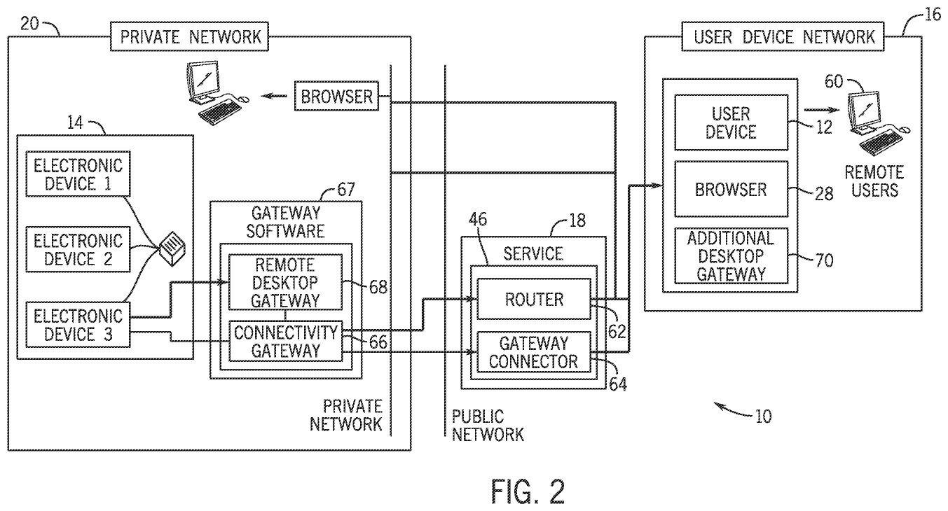

The memory 42 may be similar to and/or the same as the memory 24. Additionally, the memory 42 may include a service 46 (e.g., a cloud service). The server 38 may be provisioned or deployed on-demand by the user device 12 and/or the electronic device 14 to enable the deployment of the service 46. The service 46 may enable communication with other electronic devices (e.g., the electronic device(s) 14) using various communication protocols such as Hypertext Transfer Protocol (HTTP), Message Queuing Telemetry Transport (MQTT), Constrained Application Protocol (CoAP), or any other suitable communication protocol that enables communication with the other electronic devices. For example, the service 46 may be provisioned by the user device 12 and may deploy to enable communication with and/or control of the electronic device 14. As another example, the electronic device 14 may provision the service 46 to enable communication with the user device 12 when the user of the electronic device 14 desires assistance. Additional details with regard to the service 46 will be described below with regard to FIG. 2.

FIG. 2 is a block diagram of components of the remote control system 10, in accordance with present embodiments. As described herein, the remote control system 10 may include the user device 12 as part of and/or coupled to the user device network 16, and the electronic device 14 as part of and/or coupled to the private network 20. Further, the remote control system 10 may include the public network 18, which includes the service 46. As described above, the service 46 may enable communication between the user device network 16 (including the user device 12) and the private network 20 (including the electronic device 14). In some embodiments, the user device network 16 may include a private network or a public network. Additionally, the private network 20 may, in additional or alternative embodiments, include a public network. The user device 12 may send a request to the service 46 via the browser 28 to connect to the electronic device 14. Further, the request may cause a connection to be established between the user device 12 and the service 46. The connection may include a full-duplex channel (e.g., a communication channel that enables simultaneous, bi-directional transmission of data), such as a WebSocket connection, an Ethernet connection, or any other suitable connection that enables sending and receiving data concurrently. In some embodiments, the connection may include a web socket connection, which may include a bi-directional communication channel between the user device 12 and the service 46 over the public network 18

The service 46 may include a router 62 (e.g., a console feed router) and a gateway connector 64. The gateway connector 64 may act as an intermediary (e.g., a bridge) between two or more devices. That is, the gateway connector 64 may facilitate communication between the service 46 and the user device network 16 (including the user device 12), or any other suitable network or device. Further, the gateway connector 64 may enable routing of requests and responses between the user device network 16 (including the user device 12), the private network 20 (including a connectivity gateway 66), or any other network or suitable device. The gateway connector 64 may also be coupled to the router 62 and may act as an interface (e.g., a point of interaction or communication) for the connectivity gateway 66. The router 62 may include a software router or a virtual router, and may perform routing functions using software-based techniques as part of the service 46. The router 62 may direct or transmit (e.g., wirelessly) a data stream, such as a console feed, from one device or network to one or more other devices or network. For example, the router 62 may direct the data stream from the electronic device 14 to the user device 12 and vice versa.

Gateway software 67 may include the connectivity gateway 66 and a remote desktop gateway 68, and may aid in facilitating an exchange of data and/or enabling communication between the private network 20 and the service 46. That is, the gateway software 67 may serve as an entry point between the private network 20 and the service 46, or between any other suitable network or service. The gateway connector 64 may connect to and route the request of the user device 12 (e.g., the request to connect to the electronic device 14) to the connectivity gateway 66. The connectivity gateway 66 may include a software component that provides a connection between two or more different networks (e.g., the public network 18 (including the user device network 16), the private network 20, or any other suitable network), though, in additional or alternative embodiments, the connectivity gateway 66 may take other forms (e.g., a hardware device, firmware, and so on). The connectivity gateway 66 may connect or communicatively couple to the electronic device 14 and execute a remote server for the electronic device 14. The remote server may include virtual network computing (VNC), a remote desktop protocol (RDP), or any other suitable sharing system and/or protocol. In some embodiments, the remote server may run on the electronic device 14 as an additional service or an application. Alternatively, the remote server may run as an agent or through an additional browser on the electronic device. Moreover, the connectivity gateway 66 may establish the web socket connection with the service 46.

After the connectivity gateway 66 connects or communicatively couples to the electronic device 14, the connectivity gateway 66 may receive information related to the electronic device 14 and configure the information in the remote desktop gateway 68. The remote desktop gateway 68 may include any suitable clientless remote desktop gateway that enables the user to control remote devices via a web browser and supports standard protocols, such as virtual network computing (VNC), remote desktop protocol (RDP), or secure socket shell (SSH). For example, the remote desktop gateway 68 may include Apache Guacamole, which utilizes hypertext markup language 5 (HTML 5), and enables access from anywhere through access of the web browser. The connectivity gateway 66 may provide the information related to the electronic device 14 to the remote desktop gateway 68, such as an Internet Protocol (IP) address, a host name, or other relevant credential and security settings. Further, the connectivity gateway 66 may configure the information in the remote desktop gateway 68 by defining parameters that control access to and security for the remote desktop gateway 68 connection to the electronic device 14. For example, the connectivity gateway 66 may define rules for accessing the electronic device 14 based on user accounts, network locations, and/or authentication method. The information may also include a device type and model, operating system information, network information, user authentication information, security information, and/or any other suitable information related to the electronic device 14.

Further, the remote desktop gateway 68 may use the information to connect to the electronic device 14 and may receive a data stream (e.g., a traffic data stream) via the remote server. That is, the remote desktop gateway 68 may receive a continuous stream of data from the electronic device 14 or a discontinuous stream of data. The data may include source and destination internet protocol (IP) addresses, protocol information, port numbers, time stamps, packet size, a console feed, and the like. In some embodiments, the remote desktop gateway 68 may encrypt (e.g., encode) the data stream to protect the data stream transmitted between the remote desktop gateway 68 and the electronic device.

Moreover, the remote desktop gateway 68 may forward (e.g., stream) the data to the connectivity gateway 66. The connectivity gateway 66 may read the data, which may be encoded as instructions (e.g., a set of instructions) from the remote desktop gateway 68, and transmit the data to the service 46. Further, the router 62 may receive the data and transmit the data to the browser 28 of the user device 12. The browser 28 may prepare the data for display by decoding the data before rendering the data on the user interface of the user device 12.

Additionally, the user may input one or more inputs (e.g., one or more keyboard inputs and/or one or more mouse inputs) via the user interface of the browser 28 for transmission to the electronic device 14. The one or more inputs may be captured via an additional desktop gateway 70 included in the browser 28. The one or more inputs may enable the user of the user device 12 to control the operation of the electronic device 14 from a remote location. In some embodiments, the one or more inputs may enable the user of the user device 12 to edit and create protocols (e.g., define a set of guidelines or procedures), process (e.g., perform post-processing of) image data obtained by the electronic device 14, transfer Digital Imaging and Communications in Medicine (DICOM) data to nodes (e.g., move medical imaging data between different devices), edit patient exam data obtained by the electronic device 14, and/or create the protocols from medical scans obtained by the electronic device 14. Additionally or alternatively, in some embodiments, the one or more inputs may enable the user of the user device 12 to delete the patient exam data from the electronic device 14, anonymize the patient exam data, review DICOM header data, access a tool and error log to determine problems with the electronic device 14, reorder applications of the browser 28, configure network nodes, access Central Institute of Educational Technology (CIET) tools, reboot the electronic device 14 and/or modify system global preferences. For example, if the electronic device 14 included the medical device, the inputs may include a selection of an appropriate scan type, specific parameters that may be set before the scan is performed, calibration of the device, an update of a patient's position, and the like.

The router 62 may forward the one or more inputs to the connectivity gateway 66. The connectivity gateway 66 may receive the one or more inputs and enter (e.g., write) the one or more inputs to the remote desktop gateway 68 for the electronic device 14. The remote desktop gateway 68 may then forward the one or more inputs to the remote server of the electronic device 14. Thus, the one or more inputs of the user device 12 may be applied and/or implemented in or to the electronic device 14. In this manner, the user device 12 may remotely operate the electronic device 14.

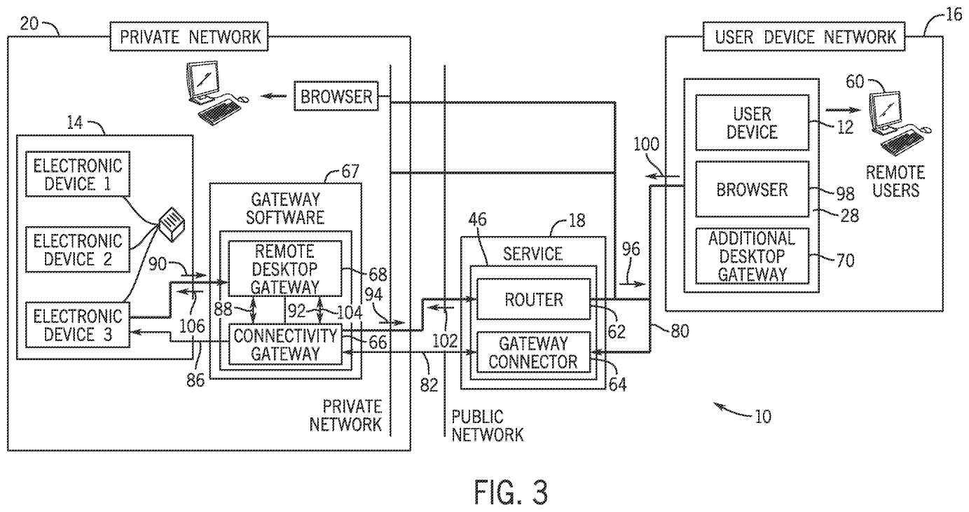

FIG. 3 is a flow diagram of processes performed in the remote control system 10, in accordance with present embodiments. In process 80, the user device 12 may send the request to the service 46 (e.g., via the browser 28) to connect to the electronic device 14 and view the console feed of the electronic device 14. That is, in some embodiments, the user device 12 may cause the request to be sent via the browser 28. The console feed may include real-time or logged information about operations, status, system logs, error messages, diagnostic data, relevant errors or events, or any other suitable updates related to the electronic device 14. That is, the console feed may provide insight into the operations of the electronic device 14 and facilitate administrative tasks, such as configuration and management of the electronic device 14. Additionally, the request by the user device 12 may cause the connection to be established between the user device 12 and the service 46.

In process 82, the gateway connector 64 may send (e.g., deposit) a message to the connectivity gateway 66 to cause the connectivity gateway 66 to execute (e.g., begin) the remote server for the electronic device 14. Thus, the connectivity gateway 66 may receive the message from the gateway connector 64. Additionally, in process 86, the connectivity gateway 66 may execute the remote server and establish the connection (e.g., the WebSocket connection) with the service 46.

In process 88, the connectivity gateway 66 may configure the information of the electronic device 14 in the remote desktop gateway 68, which may include specifying details and settings related to the electronic device 14 that may be accessed remotely through the remote desktop gateway 68. As such, the configuration of the information of the electronic device 14 in the remote desktop gateway 68 may enable communication with and streaming of data to the remote desktop gateway 68. Thus, in process 90, the remote desktop gateway 68 may connect to the electronic device 14 and receive the data stream, which may include the console feed, from the electronic device 14.

In process 92, the connectivity gateway 66 may read the data stream, which may be encoded as instructions (e.g., Apache Guacamole instructions). Moreover, in process 94, the connectivity gateway 66 may send (e.g., stream) instructions to the service 46 over the connection. Additionally, in process 96, the router 62 (communicatively coupled to the service 46) may receive the instructions, which may include the console feed. The router 62 may then forward the instructions to the user device 12 via the connection and display the instructions to the user 60 via the browser 28. In process 98, the browser 28 may decode the instructions by parsing and/or interpreting the instructions and render the decoded instructions (e.g., console feed data) on the browser 28 for view by the user 60.

In process 100, the additional remote desktop gateway 70 of the browser 28 may capture one or more inputs input at the user interface of the browser 28 (e.g., by the user). The additional remote desktop gateway 70 may then send the one or more inputs to the electronic device 14 through the service 46. Further, in process 102, the router 62 within the service 46 may forward the one or more inputs to the connectivity gateway 66 through the connection. In process 104, the connectivity gateway 66 receives the one or more inputs and enters the one or more inputs into the remote desktop gateway 68 for the electronic device 14. Moreover, in process 106, the remote desktop gateway 68 may forward the one or more inputs to the remote server of the electronic device 14. In this manner, the remote control system 10 may apply and/or implement the one or more inputs of the user device 12 to the electronic device 14. Additionally, the application and/or implementation may be displayed to (e.g., reflected on) the user device 12 for view by the user 60.

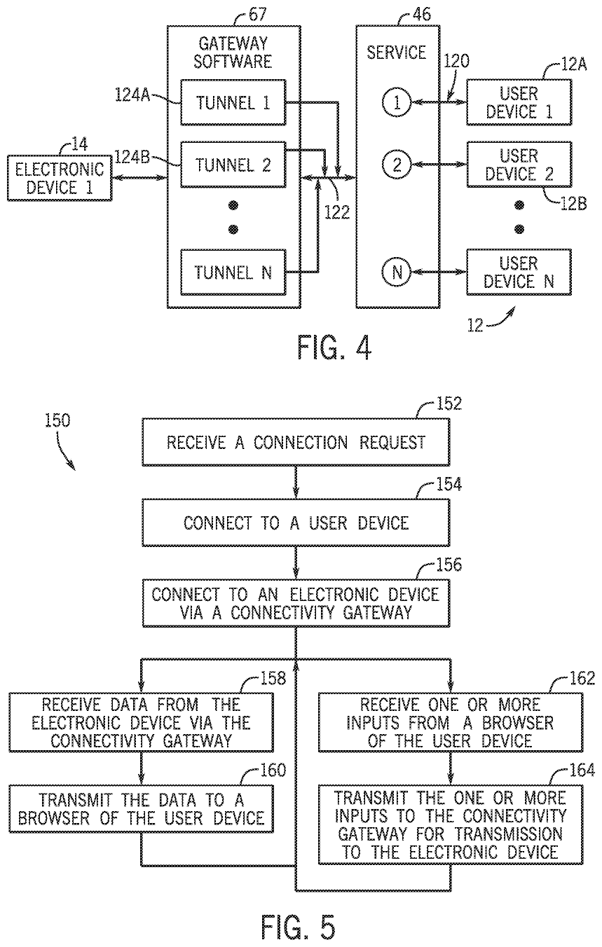

With the foregoing in mind, FIG. 4 is a block diagram of a flow of the data within the remote control system 10, in accordance with present embodiments. As described above, the first user device 12A may send the request to connect to the electronic device 14, which may be received by the service 46. Thus, the first user device 12A may establish a first connection 120 (e.g., a web socket channel) to the service 46. Moreover, the service 46 may connect to and route the connection request to the gateway software 67 (e.g., the gateway connector 64 of the gateway software 67). The gateway software 67 may establish a second connection 122 (e.g., a web socket channel) to the service 46. In addition, the gateway software 67 may establish (e.g., create) a first tunnel 124A (e.g., an Apache Guacamole tunnel), which may enable the gateway software 67 to connect to the second connection 122. Moreover, data may be read from and/or written to the remote server of the electronic device 14 through the first tunnel 124A via the application 30 on the user device 12. The first tunnel 124A may include a secure communication channel between the gateway software 67 and the second connection 122, which may be connected to the service 46 and the user device 12. In some embodiments, the first tunnel 124A may provide encryption and/or encapsulation for the stream of data to enable secure communication.

As illustrated, the electronic device 14 may be connected to the gateway software 67. Therefore, the gateway software 67 (e.g., the remote desktop gateway 68 of the gateway software 67) may receive the stream of data from the electronic device 14. The first tunnel 124A may act as an intermediary between the gateway software 67 and the second connection 122. Moreover, the gateway software 67 may be configured to use the first tunnel 124A to read the stream of data from the electronic device 14 and/or write the stream of data to the electronic device 14.

It should be noted that a respective tunnel 124 may be created for each respective user device 12 attempting to connect to the electronic device 14. For example, a second user device 12B may send the request to connect to the electronic device 14, which may be received by the service 46. Thus, a second tunnel 124B may be established by the gateway software 67. In some embodiments, the first user device 12A may be controlling the remote operation of the electronic device 14, while the second user device 12B may view information related to the electronic device 14. Additionally, it should be noted that while only the first user device 12 and the second user device 12 are discussed, any suitable number of user devices 12 and tunnels 124 may be implemented for use.

Instructions (e.g., a message and/or the stream of data) associated with each tunnel of the first tunnel 124A and/or the second tunnel 124B may be written and transmitted to the service 46 via the second connection 122 (e.g., a single web socket channel). Each instruction of the instructions may include a user identification (ID), which may allow transmission of the instruction to the associated user device 12. That is, the service 46 may receive the instructions, including the user ID, and separate the instructions according to the user ID of each user device 12. The service 46 may then route each of the instructions to the browser 28 of each associated user device 12. The browser 28 may be configured to read and/or display the instructions.

As an example, the stream of data from the first tunnel 124A may be associated with instructions for remotely controlling the electronic device 14, and the stream of data from the second tunnel 124B may be associated with instructions for viewing information related to the electronic device 14. The instructions for remotely controlling the electronic device 14 and viewing information related to the electronic device 14 may be written to the second connection 122 (e.g., the web socket channel). Additionally, the instructions for remotely controlling the electronic device 14 may include the user ID of the first user device 12A, and the instructions for viewing information related to the electronic device 14 may include the user ID of the second user device 12B. Therefore, the service 46 may receive the instructions and separate the instructions for remotely controlling the electronic device 14 to route to the first user device 12A. Further, the service 46 may separate the instructions for viewing information related to the electronic device 14 and route the instructions to the second user device 12B.

In a similar manner, the first user device 12A may enter one or more inputs (e.g., entered by the user) to remotely control the operation of the electronic device 14. The instructions associated with the one or more inputs may be sent to the service 46, which may then send the instructions to the gateway software 67 via the second connection 122. The gateway software 67 may then forward the instructions to the electronic device 14 for application to and/or implementation in the electronic device 14.

Keeping this in mind, FIG. 5 is a flow diagram of a process 150 to initiate remote control between the user device 12 and the electronic device 14, in accordance with present embodiments. Any suitable device (e.g., a controller) that may control components of the server 38, such as the processor 40 or the transceiver 44, may perform the process 150. In some embodiments, the process 150 may be implemented by executing instructions stored in a tangible, non-transitory, computer-readable medium, such as the memory 42, using the processor 40 or the transceiver 44. For example, the process 150 may be performed at least in part by one or more software components, such as an operating system of the server 38, one or more software applications of the server 38, and the like. While the process 150 is described using steps in a specific sequence, it should be understood that the present disclosure contemplates that the described steps may be performed in different sequences than the sequence illustrated, and certain described steps may be skipped or not performed altogether.

At process block 152, the processor 40 receives a connection request from the user device 12. That is, the processor 40 receives a request to establish a connection to the user device 12, sent by the user device 12 via the browser 28. Therefore, at process block 154, the processor 40 connects to the user device 12. As described above, the processor 40 connects to the user device 12 by establishing the connection, which may include the WebSocket connection.

At process block 156, the processor connects to the electronic device 14 via the connectivity gateway 66, which may include the software component that provides the connection between two or more different networks (such as the public network 18 (including the user device 12) and the private network 20). As described above, the connectivity gateway 66 may connect to the electronic device 14 and execute the remote server for the electronic device 14. Further, the connectivity gateway 66 may receive information related to the electronic device 14 and configure the information in the remote desktop gateway 68. The remote desktop gateway 68 may then use the information to connect to the electronic device 14, receive data (e.g., a stream of data) from the electronic device 14, and forward the data to the connectivity gateway 66. Therefore, at process block 158, the processor 40 receives the data from the electronic device 14 via the connectivity gateway 66. At process block 160, the processor 40 transmits the data to the browser 28 of the user device 12. The browser 28 may then prepare the data for display on the user interface of the user device 12.

In some embodiments, the electronic device 14 may transmit one or more inputs via a user interface of the electronic device 14 for transmission to the user device 12. Moreover, the one or more inputs may enable the user of the electronic device 14 to transmit additional information to the user device 12. For example, the additional information may include health-related information about a patient the user is using the electronic device 14 on, a status of the electronic device 14, malfunctions (e.g., errors) of the electronic device 14, or a request for telecommunication. Further, the one or more inputs of the electronic device 14 may be included in the data transmitted to the browser 28 of the user device 12 at process block 160. Thus, the one or more inputs of the electronic device 14 may be implemented and/or presented (e.g., displayed) in the user device 12. For example, the one or more inputs may be presented via the browser 28. In this manner, the electronic device 14 may provide the additional information to the user device 12.

After the data is transmitted to the browser 28 of the user device 12, at process block 162, the processor 40 receives one or more inputs from the browser 28 of the user device 12. As described above, the one or more inputs may enable the user of the user device 12 to control the operation of the electronic device 14 from the remote location. At process block 164, the processor 40 transmits the one or more inputs to the connectivity gateway 66 for transmission to the electronic device 14. That is, the connectivity gateway may receive the one or more inputs and enter the one or more inputs to the remote desktop gateway 68 for transmission to the electronic device 14. Thus, the one or more inputs of the user device 12 may be applied and/or implemented in or to the electronic device 14. In this manner, the user device 12 may remotely operate the electronic device 14.

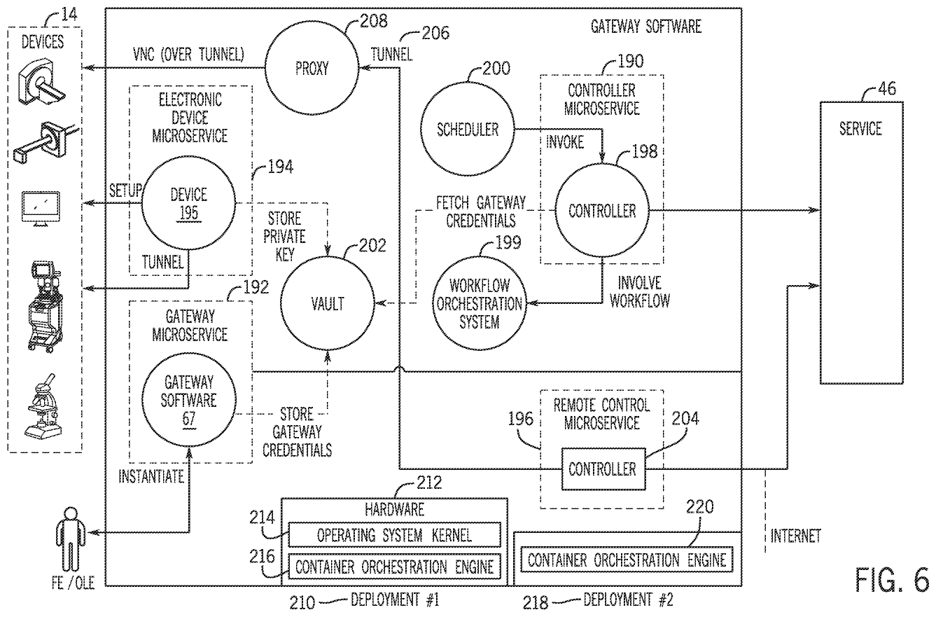

With the foregoing in mind, FIG. 6 is a block diagram of components of the gateway software 67 within the remote control system 10, in accordance with present embodiments. As described above and shown in FIG. 6, the electronic device 14 may include the medical device. The gateway software 67 may include a controller microservice 190, a gateway microservice 192, an electronic device microservice 194, and a remote control microservice 196. The controller microservice 190 may monitor one or more commands deposited and/or forwarded by the service 46 and begin a workflow within the gateway software 67 via a controller 198. Additionally, the controller microservice 190 may receive information from a scheduler 200 regarding when to read the one or more commands deposited and/or forwarded by the service 46 based on resource availability, demand, and other factors. The controller microservice 190 may invoke a workflow via a workflow orchestration system 199, which may define the workflow in a configuration file. Further, the workflow orchestration system 199 may host the workflow. The controller microservice 190 may fetch gateway credentials and store the gateway credentials in a vault 202, which may store a number of credentials, secrets, keys, and so on generated within the gateway software 67.

The gateway microservice 192 may perform an initial handshake (e.g., a process through which devices establish communication and negotiate terms of a connection) between the service 46 and the gateway software 67. Further, once the handshake is complete, a secret may be generated in the gateway software 67 and the application via a key exchange algorithm (e.g., Diffie-Hellman key exchange algorithm) to enable the gateway software 67 and the service 46 to communicate with one another. The secret may then be stored in the vault 202.

The electronic device microservice 194 (including any suitable device 195 configured to run the gateway software 67) may establish a tunnel (e.g., a connection) with the electronic device 14 via a protocol (e.g., a secure shell (SSH) protocol) and begin the remote server on the electronic device 14. After establishing the tunnel, communication between the electronic device microservice 194 and the electronic device 14 may occur via the tunnel. Further, the electronic device microservice 194 may store a private key associated with the protocol in the vault 202.

The remote control microservice 196 may forward data (e.g., a stream of data) from the electronic device 14 to the application within the service 46 via a controller 204. Moreover, the remote control microservice 196 may receive the one or more inputs from the browser 28 of the user device 12 and send the one or more inputs to the electronic device 14. Each electronic device 14 may be associated with a respective remote control microservice 196. The one or more inputs may be sent via a tunnel 206 and pass through a proxy 208 (e.g., a Guacamole proxy daemon (guacd)).

The gateway software 67 may be deployed on any platform that may support container orchestration. Container orchestration may include a process of automating and managing deployment, scaling, and operation of containerized applications within servers or nodes. A first deployment 210 may be implemented and managed by user 60 and may be implemented for deployment of the gateway software 67. For example, the user 60 may provide hardware 212, which may be installed with an operating system kernel 214 (e.g., a subsystem for Linux) and a container orchestration engine 216. Once the container orchestration is setup, the gateway software 67 may be installed on the hardware 212.

A second deployment 218 may be deployed on a platform associated with the electronic device 14. The gateway software 67 may run on the second deployment 218 as the application. The second deployment may include a container orchestration engine 220, which may automate deployment, scaling, management, and operations of a containerized application.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

This written description uses examples to disclose the present subject matter, including the best mode, and also to enable any person skilled in the art to practice the subject matter, including making and using any devices or systems and performing any incorporated methods. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. One or more tangible, non-transitory, machine-readable media, comprising machine-readable instructions that, when executed by one or more processors, cause the one or more processors to:
receive a connection request from a user device, wherein the user device is coupled to a first private network;
connect to the user device;
connect to an electronic device via a connectivity gateway by passing through a firewall, wherein the electronic device is coupled to a second private network comprising the firewall, and the second private network is coupled to the first private network via a public network;
receive data from the electronic device via the connectivity gateway;
transmit the data to a browser of the user device;
receive one or more inputs from the browser of the user device; and
transmit the one or more inputs to the connectivity gateway for transmission to the electronic device.

2. The one or more tangible, non-transitory, machine readable media of claim 1, wherein the data comprises a set of instructions for controlling operation of the electronic device, viewing electronic device information, or any combination thereof.

3. The one or more tangible, non-transitory, machine readable media of claim 1, wherein the instructions are configured to cause the one or more inputs to control operation of the electronic device.

4. The one or more tangible, non-transitory, machine readable media of claim 3, wherein the one or more inputs comprise a scan type, parameters, calibration data, a patient position, or any combination thereof.

5. The one or more tangible, non-transitory, machine readable media of claim 1, wherein the instructions are configured to cause the connectivity gateway to connect to the electronic device and execute a remote server for the electronic device.

6. The one or more tangible, non-transitory machine readable media of claim 5, wherein the instructions are configured to cause the connectivity gateway to receive electronic device information and configure the electronic device information in a remote desktop gateway.

7. The one or more tangible, non-transitory, machine readable media of claim 6, wherein the instructions are configured to cause the connectivity gateway to receive the data from the electronic device via the remote desktop gateway.

8. The one or more tangible, non-transitory, machine readable media of claim 1, wherein the electronic device comprises a medical device.

9. A device comprising:
a transceiver; and
a processor configured to:
receive a connection request and connect to a first user device;
connect to a first electronic device coupled to a private network comprising a firewall, wherein connecting to the first electronic device comprises passing through the firewall;
receive data from the first electronic device;
transmit the data to a first browser of the first user device;
receive one or more inputs from the first browser of the first user device; and
transmit the one or more inputs to the first electronic device.

10. The device of claim 9, wherein the processor is configured to connect to the first electronic device via a first tunnel associated with the first user device.

11. The device of claim 10, wherein the processor is configured to:
receive an additional connection request and connect to a second user device;
connect to the first electronic device and receive the data from the first electronic device;
transmit the data to a second browser of the second user device; and
cause the second user device to display the data.

12. The device of claim 11, wherein the processor is configured to connect to the first electronic device via a second tunnel associated with the second user device.

13. The device of claim 12, wherein the processor is configured to read data from and write data to the first electronic device via the first tunnel, the second tunnel, or any combination thereof.

14. The device of claim 12, wherein each of the first tunnel and the second tunnel are configured to encrypt the data, encapsulate the data, or any combination thereof.

15. The device of claim 9, wherein the processor is configured to receive instructions via a first tunnel, a second tunnel, or both, and wherein the instructions are associated with the first user device or a second user device.

16. The device of claim 15, wherein the processor is configured to send the instructions to the first user device or the second user device based on a user identification associated with the instructions.

17. The device of claim 16, wherein a first instruction of the instructions controls the first electronic device, and wherein a second instruction of the instructions causes display of information associated with the first electronic device.

18. A method comprising:
connecting, via a public network, to a user device coupled to a first private network;
connecting, via the public network, to an electronic device coupled to a second private network by passing through a firewall;
receiving data from the electronic device;
transmitting the data to a browser of the user device;
receiving a first set of inputs from the browser of the user device;
transmitting the first set of inputs to the electronic device;
receiving a second set of inputs from the electronic device; and
transmitting the second set of inputs to the user device.

19. The method of claim 18, wherein the second set of inputs comprise health-information, a status of the electronic device, a malfunction of the electronic device, a request for telecommunication, or any combination thereof.

20. The method of claim 19, comprising presenting the second set of inputs in the browser of the user device.
